(19) United States
(12) Patent Application Publication
(10) Pub. No.: US 2013/0092275 A1
(43) Pub. Date: Apr. 18, 2013

(54) Dual Containment Pipe End Cap

(71) Applicants: Charles Charlson, Rogers, MN (US); Gregory Charlson, Anoka, MN (US)

(72) Inventors: Charles Charlson, Rogers, MN (US); Gregory Charlson, Anoka, MN (US)

(21) Appl. No.: 13/650,685

(22) Filed: Oct. 12, 2012

Related U.S. Application Data
(60) Provisional application No. 61/547,436, filed on Oct. 14, 2011.

(51) Int. Cl. F16L 55/10

(52) U.S. Cl. 138/89

(57) ABSTRACT

An end cap for a containment pipe surrounding a pipe used to transfer fluid include a first fitting including a coupling body configured to be coupled to the pipe, and a reducer having first and second ends, a diameter of the first end of the reducer being less than a diameter of the second end of the reducer, and the first end of the reducer being coupled to the coupling body, and a second fitting including a cap having an open end defining an aperture, and a main body coupled to a second end of the cap, the main body being configured to be coupled to the containment pipe. The reducer is inserted into the aperture of the open end of the cap, and the cap is coupled to the reducer to form the end cap.

### RELATED APPLICATION(S)

This application claims the benefit of U.S. Patent Application Ser. No. 61/547,436 filed on Oct. 14, 2011, the entirety of which is hereby incorporated by reference.

### BACKGROUND

Pipes are used to carry fluid from a source to a destination. In many instances, pipes are buried to minimize the impact of the pipes on the surrounding environment. For example, during the production of petroleum, brackish water having a higher salinity than fresh water is needed. The brackish water can be pumped from a source to the site of production using underground pipes. Likewise, waste water can be pumped from the production site to a site for treatment and/or disposal of the water.

Should one of these pipes leak or burst, the release of the water can have a negative impact on the surrounding environment. For example, if water from the pipe leaks into a stream or other body of water, the contamination can impact wildlife in and around the water. In addition, if a portion of the pipe extending under a structure such as a roadway bursts, the resulting water pressure can rupture the roadway or cause other damage.

### SUMMARY

In one aspect, an end cap for a containment pipe surrounding a pipe used to transfer fluid, includes: a first fitting including a coupling body configured to be coupled to the pipe, and a reducer having first and second ends, a diameter of the first end of the reducer being less than a diameter of the second end of the reducer, and the first end of the reducer being coupled to the coupling body; and a second fitting including a cap having an open end defining an aperture, and a main body coupled to a second end of the cap, the main body being configured to be coupled to the containment pipe. The reducer is inserted into the aperture of the open end of the cap, and the cap is coupled to the reducer to form the end cap.

In another aspect, an end cap for a containment pipe surrounding a high-density polyethylene pipe used to transfer fluid includes: a first fitting including a coupling body having a plurality of barbs that are configured to be coupled to the high-density polyethylene pipe by hydraulically pressing the containment pipe into the plurality of barbs, and a reducer having first and second ends, a diameter of the first end of the reducer being less than a diameter of the second end of the reducer, and the first end of the reducer being welded to the coupling body, and a second fitting including a cap having an open end defining an aperture that is sized to allow the reducer to be inserted therethrough, and a main body coupled to a second end of the cap, a diameter of the open end of the cap being less than a diameter of the second end of the cap, the main body having a plurality of barbs on the outer diameter that are configured to be coupled to the containment pipe. The reducer is inserted into the aperture of the open end of the cap, and the cap is welded to the reducer to form the end cap.

In yet another aspect, a containment system for a pipe used to transfer fluid includes: a containment pipe having first and second ends; and first and second end caps, each end cap including: a first fitting including a coupling body configured to be coupled to the pipe, and a reducer having first and second ends, a diameter of the first end of the reducer being less than a diameter of the second end of the reducer, and the first end of the reducer being coupled to the coupling body; and a second fitting including a cap having an open end defining an aperture, and a main body coupled to a second end of the cap, the main body being configured to be coupled to the containment pipe. The reducer is inserted into the aperture of the open end of the cap, and the cap is coupled to the reducer to form the end cap, and the first end cap is coupled to the first end of the containment pipe and the second end cap is coupled to the second end of the containment pipe.

### DRAWINGS

FIG. 1 is a schematic view of an example environment including a buried pipe running therethrough.

FIG. 2 is a side view showing hidden lines of an example pipe including dual containment pipe end caps.

FIG. 3 is a side view in partial cross-section and showing hidden lines of one example end cap of FIG. 2.

FIG. 4 is a perspective view of an example first fitting of the end cap of FIG. 3.

FIG. 5 is a side view in partial cross-section and showing hidden lines of the first fitting of FIG. 4.

FIG. 6 is a perspective view of an example second fitting of the end cap of FIG. 3.

FIG. 7 is a side view in partial cross-section and showing hidden lines of the second fitting of FIG. 6.

### DETAILED DESCRIPTION

This application is directed to examples of a pipe including dual containment pipe end caps.

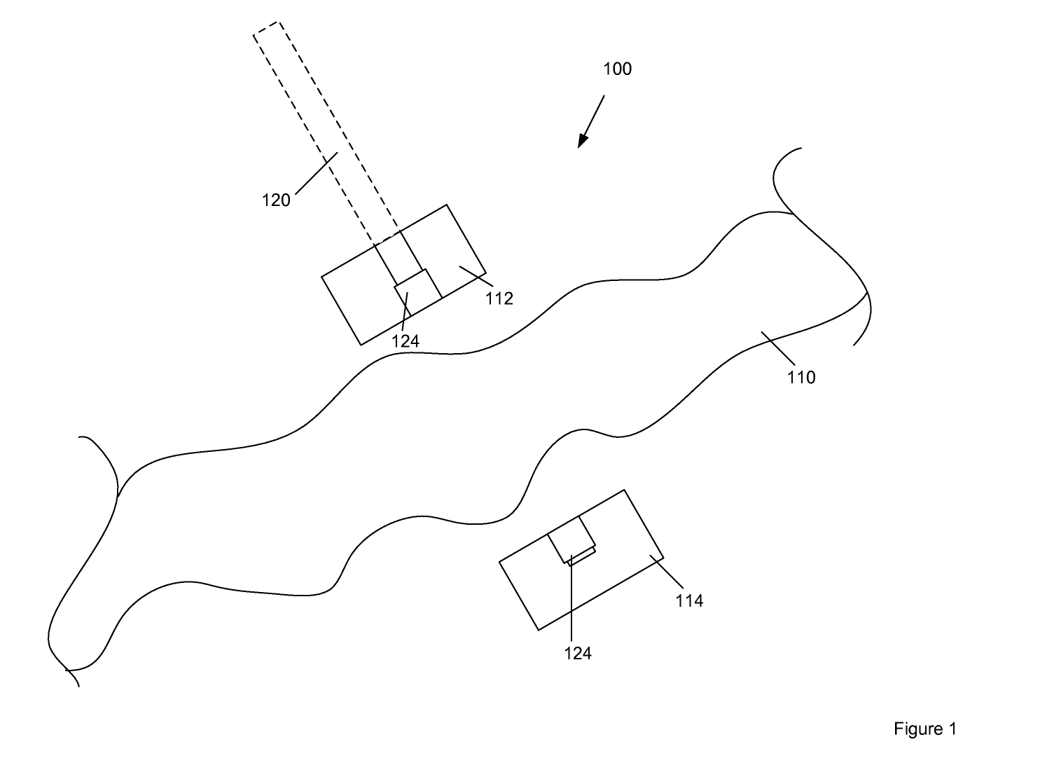

Referring now to FIG. 1, an example environment 100 is shown. This environment 100 includes a body of water 110 and a pipe 120 that runs underground and underneath the body of water 110.

In the example, the body of water 110 is a stream or river. However, in other examples, the body of water 110 can be other types of sensitive environmental areas, such as wetlands, lakes, etc. In other examples, the body of water 110 can instead be a structure, such as a roadway or building. Other applications are possible.

The pipe 120 is configured to carry a fluid from a source to a destination. In this example, the pipe 120 is buried underground. At the point at which the pipe 120 intersects the body of water 110, trenches 112, 114 are dug on opposite sides of the body of water 110, and a horizontal hole is drilled under the body of water 110. A containment pipe 124 is then inserted into the hole extending underneath the body of water 110. The containment pipe 124 is coupled to the pipe 120 in the example manner described below. The containment pipe 124 is configured to minimize a risk of leakage and/or bursting of the pipe 120 as the pipe 120 extends underneath the body of water 110.

In example embodiments, the pipe 120 and the containment pipe 124 are made of high-density polyethylene (HDPE). In this example, the pipe 120 is a 6 inch SDR 7 PE4710, and the containment pipe 124 is a 14 inch SDR 7 PE4710, both manufactured by WL Plastics Inc. of Mills, Wyo. Other types of pipes can be used.

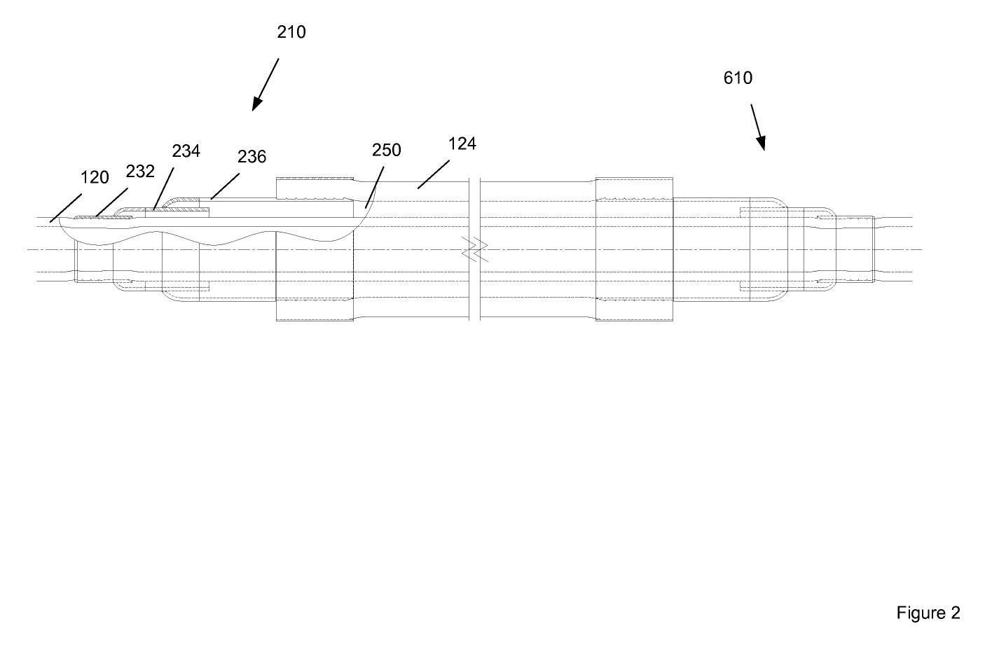

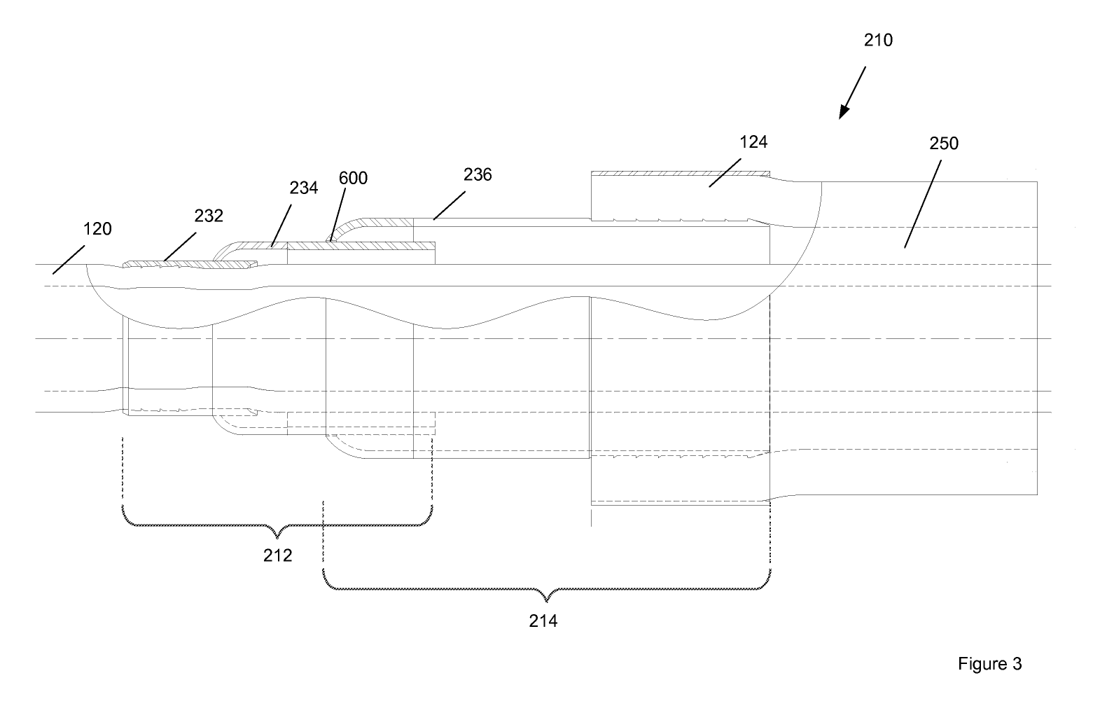

Referring now to FIGS. 2 and 3, the connections between the pipe 120 and the containment pipe 124 are shown. Generally, the connection is made by end caps 210, 610 installed at the opposite ends of the containment pipe 124. The end caps 210, 610 are identical, mirror images in construction. Each of the end caps 210, 610 includes first and second fittings 212, 214 that provide the transition between the containment pipe 124 and the pipe 120.

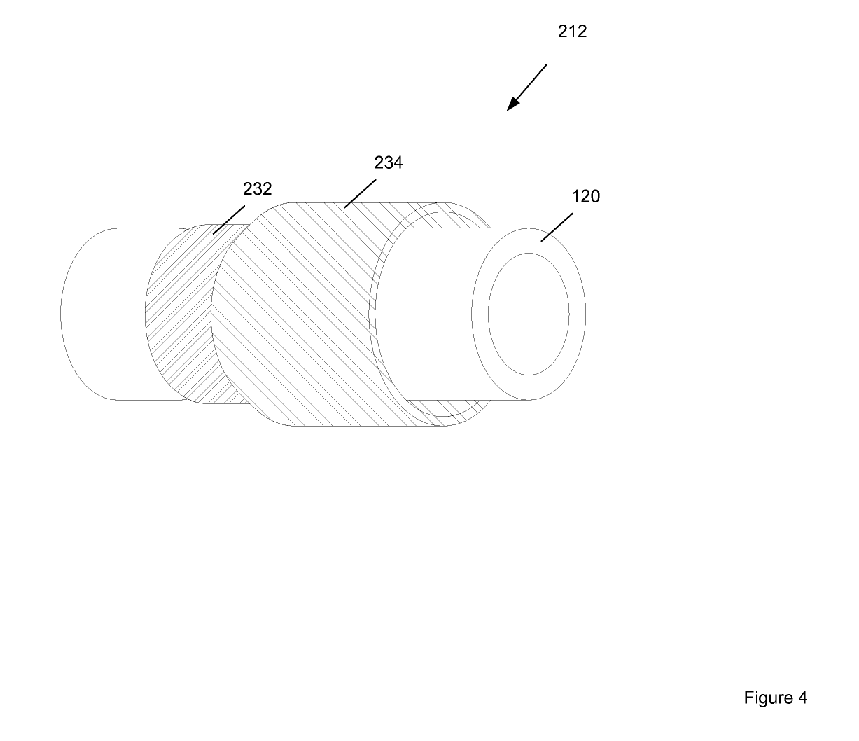

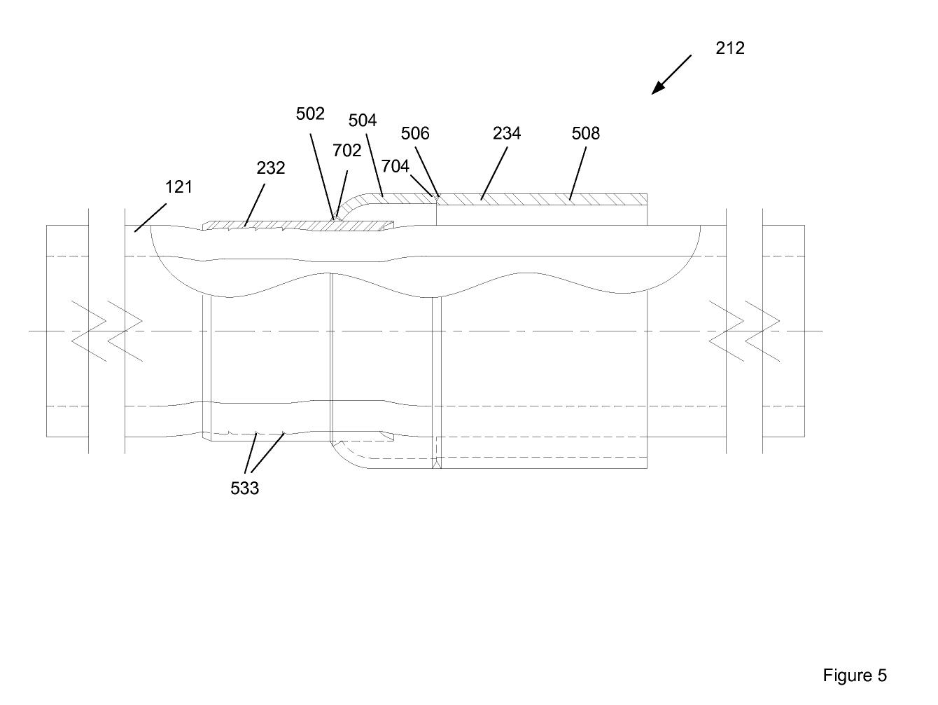

Referring now to FIGS. 4 and 5, the first fitting 212 is shown. The first fitting 212 generally includes a coupling body 232 and a reducer 234.

The coupling body 232 is a rigid cylinder, such as steel, that is positioned around a length of pipe 121 that is similar or the same in size as the pipe 120. In one example, the pipe 121 is 60 inches in length, and the coupling body 232 is 6 inches in length. The pipe 121 is sufficiently long so that the exposed free end of the pipe 121 can be welded to the pipe 120 that extends beyond the body of water 110.

The pipe 121 is hydraulically pressed into the coupling body 232. The coupling body 232 has internal barbs 533 that create a pressure seal and restrains the coupling body 232 from moving under expansion and contraction forces cause by temperature changes. In one example, the coupling body 232 is a pipe junction device similar to that disclosed in U.S. Pat. No. 5,211,429 filed on Sep. 9, 1991, the entirety of which is hereby incorporated by reference.

The reducer 234, also of steel, is welded to the coupling body 232 at a point 502. In this example, the reducer 234 includes two pieces, a first piece 504 that is welded to the coupling body 232 at a first end 702, and a second piece 508 that is welded to the first piece 504 at a point 506 at a second end 704. In this example, the first piece 504 is 3 inches in length, and the second piece 508 is 24 inches in length. A diameter of the first end 702 of the first piece 504 is less than a diameter of the second end 704 of the first piece 504. In alternative designs, the reducer 234 can be formed from a single piece of metal.

The inside diameter of the second piece 508 is greater than the outside diameter of the pipe 121. For example, in one embodiment, the outer diameter of the pipe 121 is 6.625 inches, while the inner diameter of the second piece 508 is 7.981 inches. Other configurations are possible.

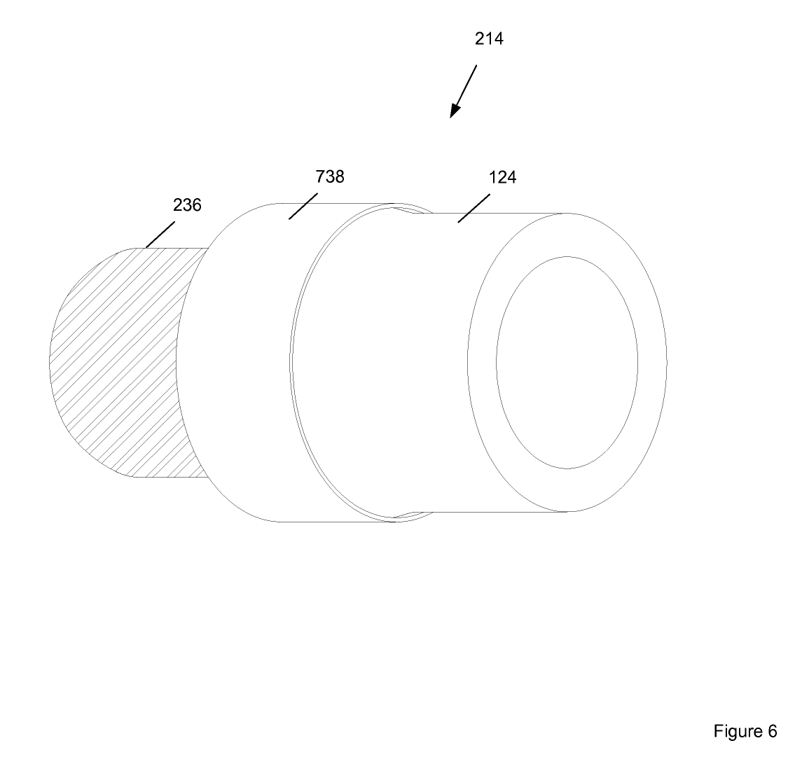

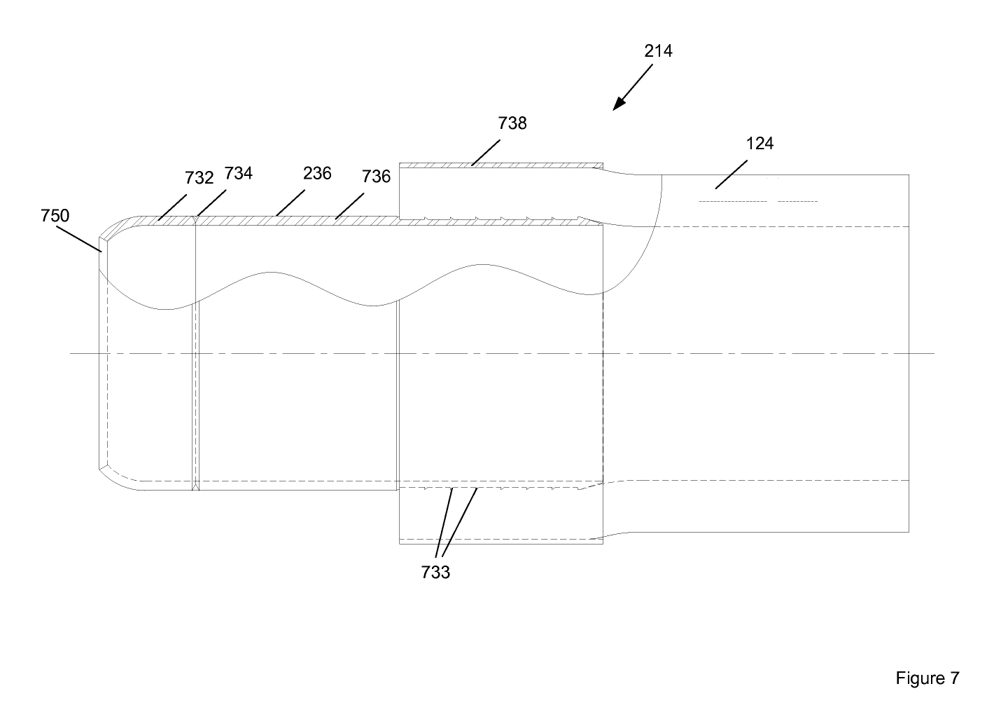

Referring now to FIGS. 6 and 7, the second fitting 214 is shown. The second fitting 214 generally includes a piece 236, formed of steel.

In this example, the piece 236 includes a main body 736 having barbs 733 formed on an outer diameter thereof to engage the containment pipe 124. An outer plate 738 is used to sandwich an end of the containment pipe 124 between the outer plate 738 and the main body 736 to couple the main body 736 to the containment pipe 124 in a similar manner to that described above.

The opposite end of the main body 736 is welded to a cap 732 at a point 734. The cap 732, in turn, has an aperture 750 formed therein, such as by cutting the cap 732 at the desired location. A diameter of the aperture 750 is sized to allow the reducer 234 to be inserted therethrough to connect the first fitting 212 to the second fitting 214, as described below.

Referring back to FIGS. 2 and 3, the first fitting 212 is coupled to the second fitting 214 by inserting the reducer 234 into the aperture 750 formed by the cap 732. In this position, the cap 732 is welded to the reducer 234 to couple the first fitting 212 to the second fitting 214.

With the fittings 212, 214 welded in this manner, the end cap 210 is formed having a rating that meets at least the same pressure rating as the pipe 120. Since the containment pipe 124 has a larger diameter than the pipe 120 (e.g., the containment pipe 124 can have a diameter of 14 inches), the containment pipe 124 surrounds the pipe 120. A space 250 is formed between the outer diameter of the pipe 120 (6.625 inches) and the inner diameter of the containment pipe 124 (14 inches). This space can be used to trap any fluid that leaks from the pipe 120 during transfer. In some examples, pressure gauges contained in one or both of the pipe 120 and the containment pipe 124 can be used to sense such a leak.

In example embodiments, the fittings 212, 214 are manufactured and provided at the job site, such as at the trenches 112, 114. The fitting 212 is coupled to the pipe 120, and the fitting 214 is coupled to the containment pipe 124. At this point, the fittings 212, 214 are welded at point 600 to form the end cap 210. A similar process is done to form the end cap 610.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. An end cap for a containment pipe surrounding a pipe used to transfer fluid, the end cap comprising:
a first fitting including a coupling body configured to be coupled to the pipe, and a reducer having first and second ends, a diameter of the first end of the reducer being less than a diameter of the second end of the reducer, and the first end of the reducer being coupled to the coupling body; and
a second fitting including a cap having an open end defining an aperture, and a main body coupled to a second end of the cap, the main body being configured to be coupled to the containment pipe;
wherein the reducer is inserted into the aperture of the open end of the cap, and the cap is coupled to the reducer to form the end cap.

2. The end cap of claim 1, wherein the pipe is a high density polyethylene pipe.

3. The end cap of claim 1, wherein the first fitting is formed of steel.

4. The end cap of claim 1, wherein the coupling body is a pipe junction device.

5. The end cap of claim 1, wherein a plurality of barbs are formed on an inner surface of the coupling body.

6. The end cap of claim 5, wherein the coupling body is configured to be coupled to the pipe by hydraulically pressing the pipe into the plurality of barbs.

7. The end cap of claim 1, wherein the reducer is formed from a single piece of metal.

8. The end cap of claim 1, wherein the reducer is formed from a plurality of coupled pieces of metal.

9. The end cap of claim 1, wherein the first end of the reducer is welded to the coupling body.

10. The end cap of claim 1, wherein the second fitting is formed of steel.

11. The end cap of claim 1, wherein the diameter of the open end of the cap is less than the diameter of the second end of the cap.

12. The end cap of claim 1, wherein the aperture is sized to allow the reducer to be inserted therethrough.

13. The end cap of claim 1, wherein the cap is welded to the reducer.

14. The end cap of claim 1, wherein a plurality of barbs are formed on an outer surface of the main body.

15. The end cap of claim 1, wherein an outer plate is configured to sandwich the containment pipe between the outer plate and the main body.

16. An end cap for a containment pipe surrounding a high-density polyethylene pipe used to transfer fluid, the end cap comprising:
a first fitting including a coupling body having a plurality of barbs that are configured to be coupled to the high-density polyethylene pipe by hydraulically pressing the containment pipe into the plurality of barbs, and a reducer having first and second ends, a diameter of the first end of the reducer being less than a diameter of the second end of the reducer, and the first end of the reducer being welded to the coupling body; and
a second fitting including a cap having an open end defining an aperture that is sized to allow the reducer to be inserted therethrough, and a main body coupled to a second end of the cap, a diameter of the open end of the cap being less than a diameter of the second end of the cap, the main body having a plurality of barbs on the outer diameter that are configured to be coupled to the containment pipe;
wherein the reducer is inserted into the aperture of the open end of the cap, and the cap is welded to the reducer to form the end cap.

17. The end cap of claim 16, wherein the coupling body is a pipe junction device.

18. The end cap of claim 16, wherein the first and second fittings are formed of steel.

19. A containment system for a pipe used to transfer fluid, the system comprising:
a containment pipe having first and second ends; and
first and second end caps, each end cap including:
a first fitting including a coupling body configured to be coupled to the pipe, and a reducer having first and second ends, a diameter of the first end of the reducer being less than a diameter of the second end of the reducer, and the first end of the reducer being coupled to the coupling body; and
a second fitting including a cap having an open end defining an aperture, and a main body coupled to a second end of the cap, the main body being configured to be coupled to the containment pipe;
wherein the reducer is inserted into the aperture of the open end of the cap, and the cap is coupled to the reducer to form the end cap; and
wherein the first end cap is coupled to the first end of the containment pipe and the second end cap is coupled to the second end of the containment pipe.

20. The containment system of claim 19, wherein the containment pipe contains a pressure gauge.
